(19) United States
(12) Patent Application Publication
(10) Pub. No.: US 2014/0180860 A1
(43) Pub. Date: Jun. 26, 2014

(54) PUBLISHER COMPENSATION SYSTEM

(71) Applicants: Kas Kasravi, W. Bloomfield, MI (US); William A. Sheridan, Chandler, AZ (US)

(72) Inventors: Kas Kasravi, W. Bloomfield, MI (US); William A. Sheridan, Chandler, AZ (US)

(21) Appl. No.: 14/237,223

(22) PCT Filed: Sep. 13, 2011
(86) PCT No.: PCT/US2011/051308

§ 371 Date: Feb. 5, 2014

(51) Int. Cl. G06Q 30/06; G06Q 30/04

(52) U.S. Cl. CPC G06Q 30/0601; G06Q 30/04
USPC 705/26.1

(57) ABSTRACT

Fragments (216, 218; 344, 346) of respective publications (220, 222; 348, 350) are included in a compilation (214; 352). An instance of the compilation is sold (101; 405). In response to the inclusion of the fragments in the compilation or in response to the selling of the instance, compensation to respective publishers of the publications for the inclusion or sale is computed (102; 406) based in part on contract terms applicable to the publications.

### BACKGROUND

Educators, researchers, news reporters and others often find themselves gathering informational materials from disparate sources. For example, in an educational scenario, there may be no textbook for a course so the educator compiles books, chapters, articles, and other information sources as needed; in other cases, an educator may wish to supplement a textbook or even replace parts of it. Researchers may find that some of their “data” includes copyrighted material. In a news gathering scenario, a reporter may wish to incorporate materials from other reporters as well as materials from pre-existing copyrighted works.

### BRIEF DESCRIPTION OF THE DRAWINGS

The following figures represent examples and not the invention itself.

FIG. 1 is a flow chart of a process for selling compilations including fragments of publications.

FIG. 2 is a schematic diagram of a publication sales system implementing the process of FIG. 1.

FIG. 3 is a schematic diagram of a publication system including another publication sales system for selling compilations including fragments of publications.

FIG. 4 is a process implemented by the publication system of FIG. 3.

### DETAILED DESCRIPTION

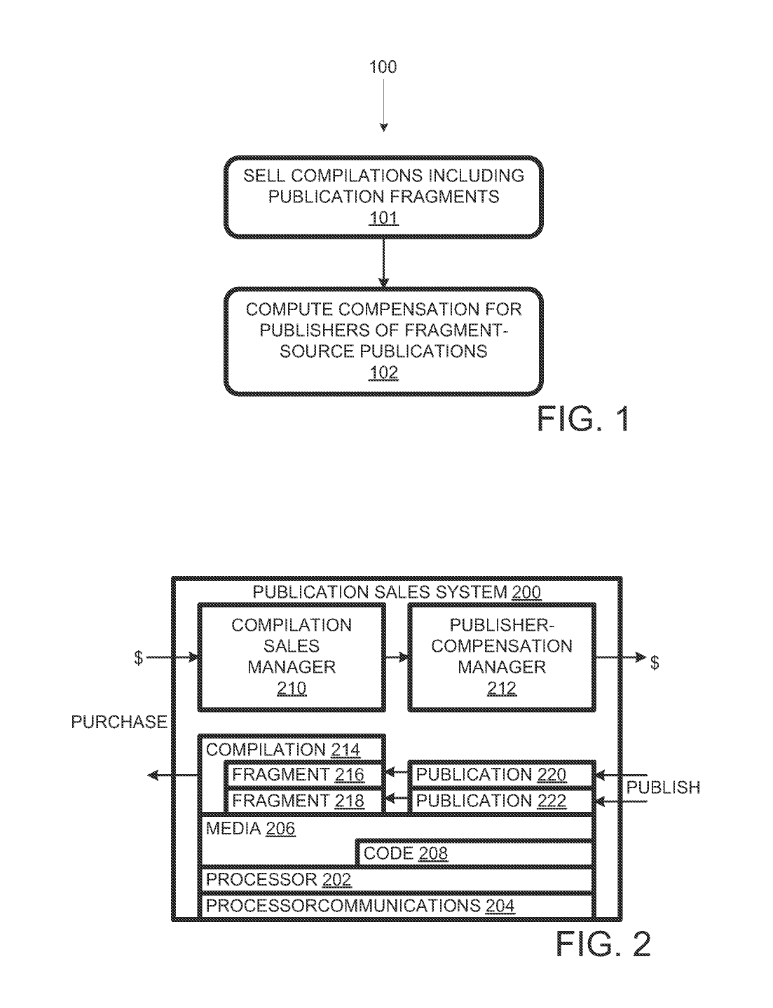

A process 100, flow charted in FIG. 1, provides for: at 101, selling a number of instances of a compilation including fragments of publications; and, at 102, computing compensation for publishers based at least on contract terms that specify compensation for source-publication fragments incorporated into compilations.

Educators, news reporters, researchers and others are accordingly enabled to compile informational materials and arrange them as desired. Purchasers need purchase only a single compilation rather than a pile of source materials. Publishers are afforded an opportunity to expand their markets to individuals who, while they may be reluctant to pay for a full publication, may be willing to pay for fragments that they actually are going to use. Finally, since the seller of the compilation takes responsibility for compensating publishers, the “compiler” designing a compilation is relieved from determining what is and what is not “fair-use”.

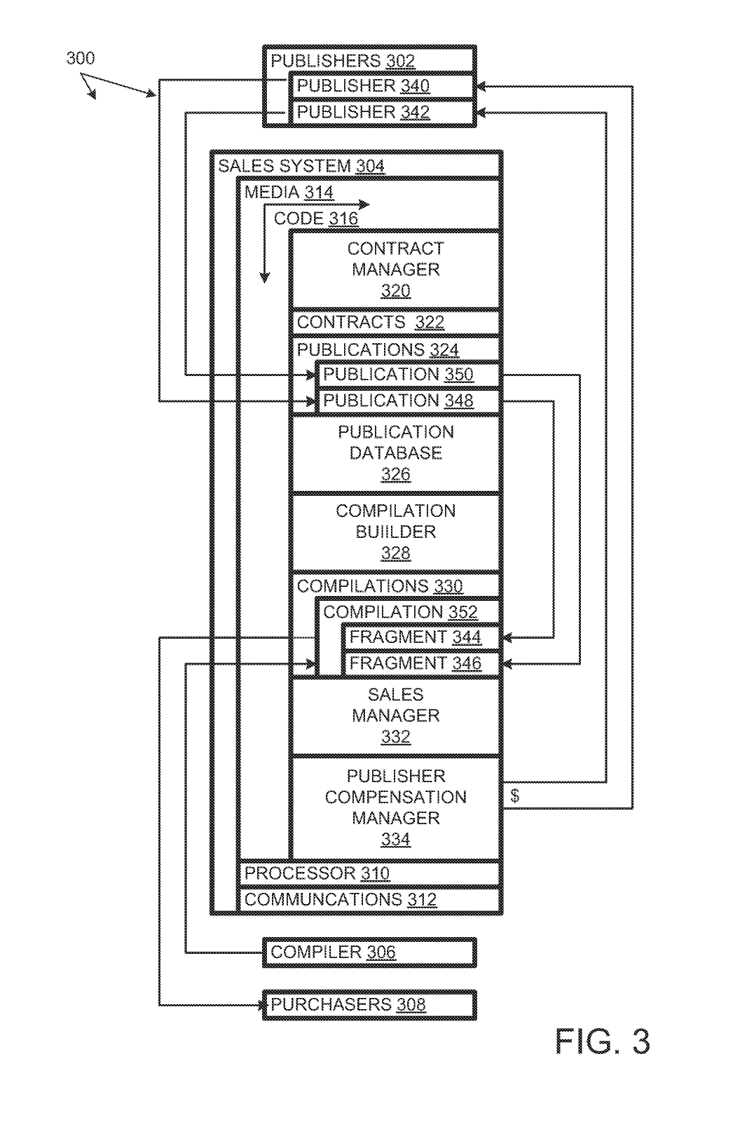

Process 100 can be implemented by a publication sales system 200, shown in FIG. 2 including a processor 202, communications devices 204, and storage media 206. Storage media 206 is encoded with code 208 configured to, when executed by processor 202, define the functionalities for a compilation sales manager 210 and for a publisher-compensation manager 212. Sales manager 210 accepts payment for compilations, e.g., compilation 214, including fragments, e.g., fragments 216 and 218, of compilation-source publications, e.g., respective publications 220 and 222. Sales manager 210 also arranges for distributions of purchased compilations to recipients. Publisher-compensation manager 212 provides for computing publisher compensation.

“Selling” herein refers to distributing instances of product instances (e.g., a compilation) to recipients in exchange for payment. Typically, payment is received from the product recipients, in which case the recipients are purchasers. However, in some cases, payment may be received from a third party, e.g., where an institution or benefactor pays for textbooks to be distributed to students. In such a case, the combination, of the recipient(s) and the payor can be considered a “purchaser”.

Depending on context, “publication” refers to: 1) informational materials made available for distribution, e.g., to purchasers; or 2) an act of making information materials available for distribution. While the compilations referred to herein are technically publications, the publications of interest herein are provided by a publisher to a publication sales system at least in part for use as source materials for compilations. In some cases, a compilation can be a source material for another compilation; for example, the individual compiling the publication may choose to include additional original materials to tie the publication together or express original ideas. Typically, the publications referred to herein are intended to be sold intact as well as in fragments; however, some publications can be collections of fragments intended for compilations with no expectation that anyone would purchase the entire publication.

“Compilation” herein refers to an ordered and unified arrangement of informational materials. Encyclopedias and poetry collections are examples of compilations. “Informational materials” refers to storage media encoded with information, e.g., in the form of text and/or graphic elements, in human cognizable form or in a form (e.g., electronic book) that can be rendered into a human cognizable form. “Graphic elements” encompasses drawings, pictures, videos, holograms and the like. “Storage media” herein refers to non-transitory tangible media used for storing human-cognizable (e.g., hard copy) or computer-readable (e.g., digital) form.

The compilations used herein include “fragments” of publications. Herein, a “fragment” is a meaningful part but less than the whole of the source (e.g., publication) from which it is taken. For example, a fragment can be a chapter, a paragraph, a sentence, or an illustration from a hard-cover book or periodical, an electronic book or periodical. The publication from which a fragment is taken can itself be a compilation. In addition to fragments, some compilations referred to herein can include as elements entire published works. Furthermore, compilations can include original content created by the compiler.

From the perspective of a publication sales system, the source of a “publication” is a “publisher”, who may or may not be an author of the publication. Herein, any person or entity that furnishes a publication to a seller, e.g., publication sales system 200, for use in compilations qualifies as a publisher.

Herein, a publisher is compensated as fragments of its publications are included in compilations. Compensation to publishers is computed at least in part based on terms of applicable contracts specifying how compensation for fragments is to be determined. In general, the compensation for use of a fragment is less than the compensation associated with sale of the incorporating publication as a whole. As detailed further below, the amount of compensation may vary according to various parameters.

Depending on the example, compensation may be fixed for any use of a given publication in a compilation. Alternatively, compensation can vary as a function of one or more parameters including: number of fragments of a publication used in a compilation, the types (text or graphic elements, e.g., drawings, pictures, videos, etc.) of fragments used, fragment size, proportion a fragment is of the publication, a portion a fragment contributes to a compilation, the market or other valuation of the publication, the popularity or prestige of the publication author or the compiler, e.g., as measured by the number of publications by that author, the citations and references to the author's work, the quality and quantity of reader reviews and sentiments as they relate to salability, the intended use of the compilation, etc. Other valuation systems, such as those disclosed in PCT Patent Application 20110016059 entitled “Valuating Intellectual Assets”, can be used as well.

Herein, “computed” means “calculated or otherwise determined using a computer system”. “Computer system” herein refers to a system including at least one computer serving as an operating system environment and including hardware resources such as a processor, communications devices, and computer-readable storage media. “Processor” herein refers to “a set of one or more single- or multi-core integrated circuits adapted for executing computer-executable code.

A publication sales system 300 includes publishers 302, a publication sales system 304, a compiler 306, and purchasers 308. Sales system 304 includes a processor 310, communications devices 312, and computer-readable storage media 314. Media 314 is encoded with code 316 that represents or defines the functionality of a contract manager 320, contracts 322, publications 324, a publication database 326, a compilation builder 328, compilations 330, a sales manager 332, and a publisher compensation manager 334.

Contract manager 320 provides for fully-automatic (e.g., via a dedicated website) as well as human-assisted contract formation with (new and existing) publishers 302. Resulting contracts 322 define the contract terms that determine publisher compensation. In particular, contracts 322 specify formulae for calculating compensation for publishers 302 based on the use of fragments of their publications 324 in compilations 330. For example, contracts 322 can be used in determining compensation to publishers 340 and 342 for use of respective fragments 344 and 346 of respective publications 348 and 350 in a compilation 352.

Publications 324 can include books, magazines, electronic equivalents and other digital media. Publications 324 includes compilation-source publications subject to contracts 322, but may include other publications, e.g., that are not authorized to be used in compilations 330. Publication database 324 includes data associating publications with their contracts, their publishers, their fragments used in compilations, and the compilations in which their fragments are used.

Compilation builder 328 is hardware programmed to assist a person, e.g., compiler 306, in creating a compilation. The programmed hardware can consist of or include a computer, part of a computer, a group of computers, e.g., a group of computers defining a cloud-based service. Compilation builder 328 serves as a front end to publication data 326 so that a compiler can locate publications from which fragments can be defined and incorporated into a compilation. Compilation builder 328 can offer suggestions regarding fragments to accompany selected fragments. Such suggestions can be based on selections made during the building of previous compilations and/or on the basis of analysis of publication contents. Building a compilation can involve defining a path, i.e., an ordered series of path elements. The path elements can include fragments of qualified (in that a suitable contract is in place) publications as well as original material, public domain material, and fair-use material.

Sales manager 332 assists purchasers 308 in browsing, selecting, and purchasing compilations 330 and publications 324. Sales manager 332 also arranges for the distribution of compilations 330 and publications 324 to recipients including purchasers 308. Distribution can include delivery of hardcopy compilations and providing download access to digital compilations. Sales manager 332 notifies publisher-compensation manager 334 when a compilation is sold.

Publisher compensation manager 334 computes compensation to publishers based on contract terms regarding compensation for the use of publication fragments. To this end, publisher-compensation manager 334 can respond to sale notifications by looking up a sold compilation in publication database 326 to identify the fragments involved in the compilation. Publication database 326 also can be used to identify the applicable contract and terms. Publisher-compensation manager 334 can compute compensation based on the applicable contract terms. Furthermore publication-compensation manager 334 can provide for payment of due compensation to publishers 302, e.g., through electronic payments.

Publication sales system 300 provides for a wide variety of contract terms. In general, the compensation for larger fragments is is greater than the compensation for smaller fragments. However, provisions are available to value some fragments more than others for reasons other than size. In most cases, compensation is tied to a number of instances of a compilation sold. However, in other cases, compensation is tied to the incorporation of a fragment in a compilation, whether or not any instances are sold.

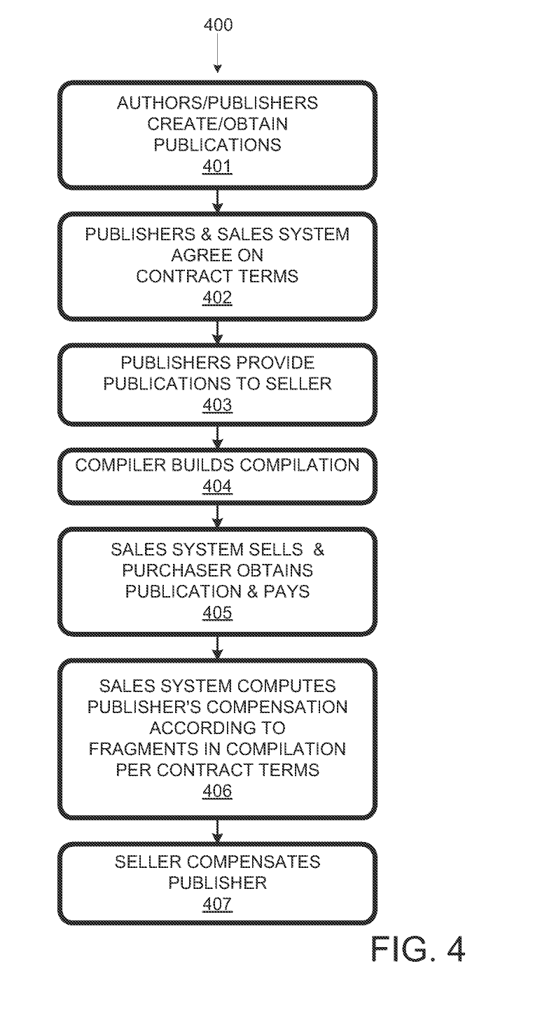

Publication system 300 implements a process 400, flow-charted in FIG. 4. At 401 authors create publications. An author can then act as a publisher and deal with publication sales system 304 directly; alternatively, a publisher can obtain a work from an author and publish at least in part by cooperating with publication sales system 304.

In either case, publishers and seller agree on contract terms and enter into a contract at 402. Contract terms can specify how a publisher is to be compensated in the event that a fragment of a publisher's publication is incorporated in a compilation or sold as part of a compilation. Once an agreement is reached, a publisher can provide a publication to the seller for purchase at 403.

At 404, a (human) compiler interacts with compilation builder 328 to build a compilation by specifying a path including publication fragments as elements. At 405, a purchaser purchases an instance of the compilation. In some cases, the compiler is also the purchaser. Alternatively, the “purchaser” is a combination of a payer that pays for the compilation and a separate recipient that receives the compilation.

At 406, publication sales system 304 computes compensation is for use of the fragment in the compilation. The computation is based on the terms in the contract governing the publication from which the fragment was extracted. The computation may take into account a number of instances sold, the proportion of the publication represented by the fragment, the proportion of the compilation represented by the fragment, and other factors. In general, contract terms can be tailored to the interests of the authors, publishers, and seller.

At 407, publication sales system 300 arranges for payment to the publisher. For example, a contribution can be made to the publisher's account for each compilation instance sold. The contributions can be aggregated over a period of time, e.g., a month, and a payment in the aggregate amount can be made (e.g., electronically) to the publisher.

As suggested above, a compiler can also be a publisher. For example, a compiler having completed a compilation can contract with a publication sales system to sale of the compilation to purchasers as at 402. This may apply in cases where the compiler has contributed original material to the compilation. Alternatively, compilation building process 404 can provide for a contract between the compiler and the sales system for sale of the compilation by the sales system. In this way, a compiler can be compensated for efforts in compiling and preparing original material, while obligations to pay for source material are met via the sales system. Concomitantly, compensation to the publishers whose publications are the sources of fragments of the compilation can reflect the fact of commercial use of the fragments, e.g., in the form of higher rates than for personal or education use.

In a scenario in which an educator creates a compilation for purchase by students, the educator can provide a unified course book tailored to the educator's preferences. Students receive course materials in a unified and appropriately ordered form. Publishers extend their market to consumers who might be willing to pay for fragments, but not for an entire publication. Since the sales system has in effect obtained the required permissions for the use of copyrighted material, the educator is freed from obtaining permissions for the use of copyrighted materials as well as from decisions regarding what does and does not constitute fair use. In addition to educators, systems 200 and 300 can benefit just about anyone interested in researching an area of interest by bringing together contributions from disparate sources.

Herein, a “system” is a set of interacting non-transitory tangible elements, wherein the elements can be, by way of example and not of limitation, mechanical components, electrical elements, atoms, physical encodings of instructions, and process segments. Herein, “process” refers to a sequence of actions resulting in or involving a physical transformation. Herein, “processor” refers to a set of one or more hardware devices capable of executing computer-executable instructions. Herein, “programmed hardware” includes any machine or device having functionality defined by machine-readable code encoded in non-transitory storage media; for example, the programmed hardware can be a computer, a mobile phone, or a cloud-based device or system.

In this specification, related art is discussed for expository purposes. Related art labeled “prior art”, if any, is admitted prior is art. Related art not labeled “prior art” is not admitted prior art.

The illustrated and other described embodiments, as well as modifications thereto and variations thereupon are within the scope of the following claims.

What is claimed is:

1. A process (100; 400) comprising:
selling (101; 405) an instance of a compilation (214; 352) including fragments (216, 218; 344, 346) of at least two respective publications (220, 222; 348, 350); and
in response to said including or said selling, computing (102; 406) compensations for respective publishers (340, 342) of said publications based in part on contract terms of contracts (322) applicable to said publications.

2. A process as recited in claim 1 further comprising a compiler (306) building said compilation,

3. A process as recited in claim 2 further comprising compensating compiler for sales of instances of said compilation.

4. A process as recited in claim 2 wherein said building involves said compiler accepting suggestions made by a programmed-hardware compilation builder.

5. A process as recited in claim 1 wherein said contract terms take into account proportions that said fragments constitute of said compilation or said publications.

6. A publication sales system (200; 304) comprising:
a hardware sales manager (210; 332) programmed to sell (101; 404) instances of a compilation (214; 352) including fragments (216, 218; 344, 346) of at least two publications (220, 222; 340, 342); and
a programed hardware publisher-compensation manager (212; 314) programmed to compute (102; 407) compensations to respective publishers (340; 342) of said publications for use of said fragments in said compilation based in part on terms of contracts (322) applicable to said publications.

7. A system as recited in claim 6 wherein at least some of said compensations are based in part on a proportion that one of said fragments represents of either said compilation or a respective one of said publications.

8. A system as recited in claim 6 further comprising a programmed-hardware compilation builder (328) configured to enable a compiler (306) to build a compilation.

9. A system as recited in claim 8 wherein said compiler is also a purchaser of said compilation.

10. A system as recited in claim 6 further comprising a publication database (326) associating said fragments with respective compilations and publications.

11. A system (200; 300) comprising computer-readable storage media (206; 314) encoded with code (208; 316) configured to, when executed by a processor (202; 310):
interact with a purchaser (308) to arrange the sale (101; 405) of a compilation (214; 352) including fragments (216, 218; 344, 346) of compilation-source publications (220, 222; 348, 350); and
compute (102; 407) compensation to publishers (340, 342) of publications based on contracts (322) including contract terms specifying how publishers are to be compensated for use of said fragments in compilations.

12. A system as recited in claim 11 further comprising said processor.

13. A system as recited in claim 11 wherein said code is further configured to interact with said purchaser to allow said purchaser to build (404) said compilation by defining a path in the form of an order series of path elements, said path elements including said fragments.

14. A system as recited in claim 13 wherein said path elements include graphic elements.

15. A system as recited in claim 11 wherein said code is further configured to interact with said publishers to agree (402) on said contract terms.
